(19) United States
(12) Patent Application Publication
(10) Pub. No.: US 2017/0240140 A1
(43) Pub. Date: Aug. 24, 2017

(54) WIPER BLADE ASSEMBLY

(71) Applicant: CAP Corporation, Sangju-si (KR)

(72) Inventors: Tae Hun KIM, Daegu (KR); Hyung Tae Kim, Incheon (KR)

(73) Assignee: CAP Corporation, Sangju-si (KR)

(21) Appl. No.: 15/439,142

(22) Filed: Feb. 22, 2017

(30) Foreign Application Priority Data
Feb. 23, 2016 (KR) 10-2016-0020931

(51) Int. Cl. B60S 1/38

(52) U.S. Cl. CPC B60S 1/3874; B60S 1/3849; B60S 2001/3812

(57) ABSTRACT

A wiper blade assembly is provided. The wiper blade assembly includes an adhering member, a lower member supporting the adhering member, an upper member spaced apart from the lower member by a predetermined gap, and pressing members coupled to the upper member and disposed between the upper member and the lower member. The elastic member is easily deformable during the operation of the wiper blade assembly.

This application claims priority to Korean Patent Application No. 10-2016-0020931, filed on Feb. 23, 2016, and all the benefits accruing therefrom under 35 U.S.C. §119, the disclosure of which is incorporated herein by reference in its entirety.

### BACKGROUND

1. Field

The present disclosure relates to a wiper blade assembly, and more particularly, to a wiper blade assembly capable of improving the adhesion between a wind shield of a vehicle and an adhering member, which wipes any foreign materials off of the wind shield.

2. Description of the Related Art

A wiper blade assembly for wiping away rain, in the case of rain, or removing foreign materials to secure a driver's visual field is disposed in a wind shield of a vehicle.

The wiper blade assembly is connected to a wiper arm connected to a driving shaft connected to a wiper driving motor of the vehicle to be driven.

Here, the wiper arm and the wiper blade assembly are connected to each other through a wiper connector. In general, the wiper blade assembly includes a clamp, to which a connector member is coupled, and the wiper arm is coupled to the connector member in a state in which the connector member is coupled to the clamp.

Meanwhile, the wiper blade assembly may be classified into a conventional type or a flat type according to the structure of a blade.

The conventional-type wiper blade assembly is configured to apply an elastic force to press a wind shield of a vehicle against a rubber strip placed in contact with the wind shield by coupling a plurality of yokes bent in an arc shape with a top-down structure and is commonly used as a typical vehicular wiper blade assembly.

The flat-type wiper blade assembly includes a single elastic member or a pair of elastic members, instead of yokes. The flat-type wiper blade assembly has a simple structure and has increasingly become popular and widespread due to its favorable appearance when it is mounted on a vehicle.

A typical wiper blade assembly includes an adhering member for wiping any foreign materials off of a windshield of a vehicle, an elastic member supporting the adhering member, and a cover member covering the end of the elastic member.

When the typical wiper blade assembly is not in operation, the elastic member, which supports the adhering member, is bent with a predetermined curvature. When the typical wiper blade assembly is in operation, the elastic member is deformed according to the shape of the wind shield, and as a result, the curvature of the elastic member changes.

Since the shape of the elastic member is changeable according to the shape of the wind shield, the adhering member supported by the elastic member can effectively wipe any foreign materials off of the wind shield.

In order for the adhering member to effectively wipe any foreign materials off of the wind shield, it is important that the elastic member, which supports the adhering member, is deformed according to the shape of the wind shield.

There are two methods for deforming the elastic member according to the shape of the wind shield, i.e., a method of dispersing a pressing pressure applied to the wiper arm through a plurality of supporting points and a method of bringing the typical wiper blade assembly into close contact with the surface of the wind shield by imparting an initial curvature to the typical wiper blade assembly.

A wiper blade assembly obtained by the latter method is the flat-type wiper blade assembly, and the inventive concept of the present disclosure is directly applicable to the flat-type wiper blade assembly.

That is, in the flat-type wiper blade assembly, an initial curvature is imparted to the elastic member so that the adhesion of the adhering member onto the surface of the wind shield can be improved without a requirement of a plurality of supporting points for dispersing the pressing pressure applied to the wiper arm. Since no particular elements are needed in connection with the plurality of supporting points, the structure of the flat-type wiper blade assembly may be simplified,

However, since in the flat-type wiper blade assembly, the adhesion properties of the elastic member with respect to the surface of the wind shield are determined by the initial curvature of the flat-type wiper blade assembly, the adhering member may not be able to be properly deformed for various wind shields with various curvatures.

Also, as described above, since the fabrication of the flat-type wiper blade assembly needs an additional process of imparting an initial curvature to the elastic member, the manufacturing cost of the flat-type wiper blade assembly increases.

### SUMMARY

Exemplary embodiments of the present disclosure provide a wiper blade assembly including an elastic member that is efficiently deformable for various wind shield surfaces with various curvatures..

Exemplary embodiments of the present disclosure also provide a wiper blade assembly capable of excluding a process of imparting an initial curvature to an elastic member.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present disclosure, a wiper blade assembly includes an adhering member, a lower member supporting the adhering member, an upper member spaced apart from the lower member by a predetermined gap, and pressing members coupled to the upper member and disposed between the upper member and the lower member.

The lower member may be an elastic member, and the upper member may be a cover member.

The pressing members may be formed as curved leaf springs or straight leaf springs.

The wiper blade assembly may further include a wiper arm coupling portion coupled to the elastic member and the cover member, or coupled to the cover member.

The pressing members may include a first pressing member, which is disposed adjacent to the wiper arm coupling portion, and a second pressing member, which is disposed adjacent to an end of the elastic member.

The first pressing member may include a first coupling part, which is coupled to a first part of the cover member, a first end, which is disposed at a first-direction end of the first pressing member with respect to the first coupling part, a second end, which is disposed at a second-direction end of the first pressing member with respect to the first coupling part, a first connecting part, which extends from the first coupling part to the first end of the first pressing member, and a second connecting part, which extends from the first coupling part to the second end of the first pressing member, and the second pressing member may include a second coupling part, which is coupled to a second part of the cover member, a first end, which is disposed at a first-direction end of the second pressing member with respect to the second coupling part, a second end, which is disposed at a second-direction end of the second pressing member with respect to the second coupling part, a first connecting part, which extends from the second coupling part to the first end of the second pressing member, and a second connecting part, which extends from the second coupling part to the second end of the second pressing member.

A length of the second connecting part of the first pressing member may be greater than a length of the second connecting part of the second pressing member.

The first pressing member may include a first coupling part, which is coupled to a first part of a cover member, a first connecting part, which is disposed in series with the first coupling part and is bent from the first coupling part at a first bent part of the first pressing member, and a first sliding part, which is disposed in series with the first connecting part and is bent from the first connecting part at a second bent part of the first pressing member, and the second pressing member may include a second coupling part, which is coupled to a second part of the cover member, a second connecting part, which is disposed in series with the second coupling part and is bent from the second coupling part at a first bent part of the second pressing member, and a second sliding part, which is disposed in series with the second connecting part and is bent from the second connecting part at a second bent part of the second pressing member.

The first connecting part may be bent from the first coupling part by a first angle, the second connecting part may be bent from the second coupling part by a second angle, and the second angle may be smaller than the first angle.

According to the aforementioned and other exemplary embodiments of the present disclosure, a wiper blade assembly including an elastic member that is easily deformable during the operation of the wiper blade assembly may be provided.

Also, since pressing members having a simple structure are provided between a cover member and the elastic member, the elastic member may be pressed by the pressing members with a pressing force provided by a wiper arm.

Also, since the elastic member is efficiently deformable for various wind shield surfaces with various curvatures by the pressing members, any foreign materials may be effectively wiped off of a wind shield of a vehicle.

Also, since the elastic member has no initial curvature, a process of imparting an initial curvature to the elastic member is not needed, and as a result, the manufacturing cost of the wiper blade assembly may be reduced.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a schematic view illustrating a wiper blade assembly according to a first exemplary embodiment of the present disclosure;

FIG. 2 is a schematic view illustrating an operating state of the wiper blade assembly according to the first exemplary embodiment;

FIG. 3 is a cross-sectional view illustrating pressing members of the wiper blade assembly according to the first exemplary embodiment;

FIG. 4 is a schematic view illustrating a wiper blade assembly according to a second exemplary embodiment of the present disclosure;

FIG. 5 is a cross-sectional view illustrating pressing members of the wiper blade assembly according to the second exemplary embodiment;

FIG. 6 is an exploded perspective view illustrating an application example of a wiper blade assembly according to an exemplary embodiment of the present disclosure;

FIG. 7 is a cross-sectional view illustrating the wiper blade assembly of FIG. 6;

FIG. 8 is a perspective view illustrating an exemplary cover member for the wiper blade assembly of FIG. 6; and

FIG. 9 is a schematic perspective view illustrating a modified example of an elastic member according to an exemplary embodiment of the present disclosure.

### DETAILED DESCRIPTION

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the present disclosure to those skilled in the art, and the present disclosure will only be defined within the scope of the appended claims.

Reference will now be made in detail to exemplary embodiments of the present invention, examples of which are illustrated in the accompanying drawings. In the drawings, like reference numerals indicate like elements. As used herein, the term “and/or” includes any and all combinations of one or more of the associated listed items.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Furthermore, relative terms such as “below,” “beneath,” or “lower,” “above,” and “upper” may be used herein to describe one element's relationship to another element as illustrated in the accompanying drawings. It will be understood that relative terms are intended to encompass different orientations of the device in addition to the orientation depicted in the accompanying drawings. For example, if the device in the accompanying drawings is turned over, elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the exemplary terms “below” and “beneath,” when used to describe a particular element's spatial relationship to another element, can encompass orientations of that element both above and below another element, depending on the orientation of the device.

Exemplary embodiments of the present disclosure will hereinafter be described with reference to the accompanying drawings.

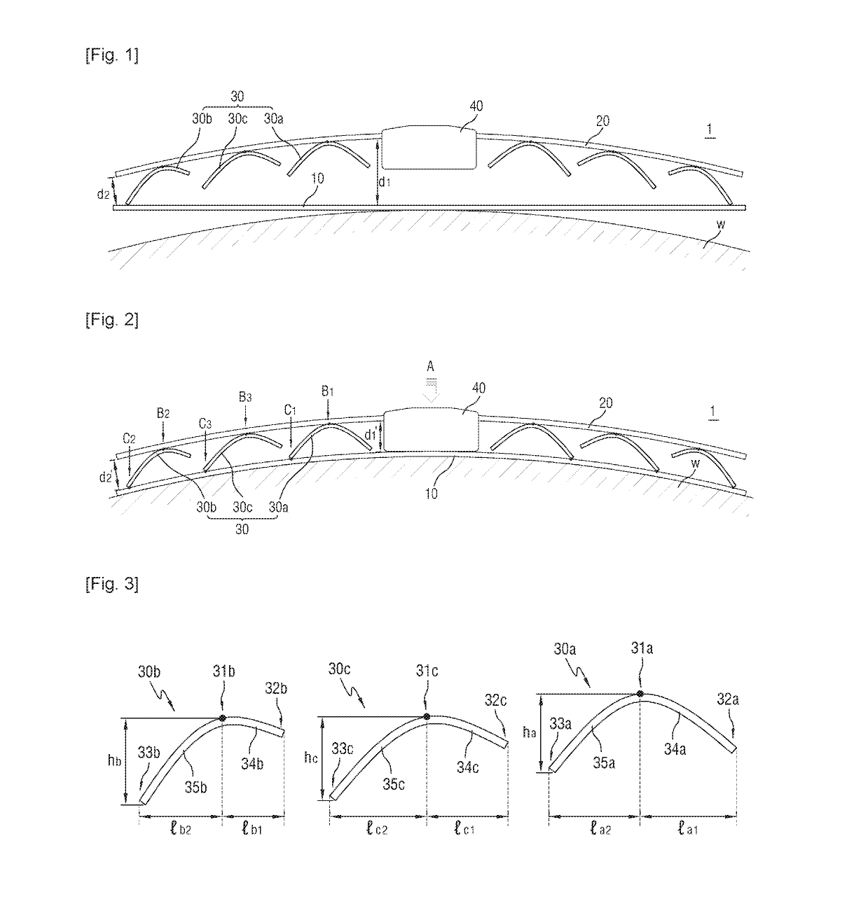

FIG. 1 is a schematic view illustrating a wiper blade assembly according to a first exemplary embodiment of the present disclosure, and FIG. 2 is a schematic view illustrating an operating state of the wiper blade assembly according to the first exemplary embodiment.

Referring to FIG. 1, a wiper blade assembly 1 includes an adhering member (not illustrated), which is formed of a rubber material and is placed in contact with a wind shield of a vehicle, a lower member 10, which supports the adhering member, an upper member 20, which is spaced apart from the lower member 10 by a predetermined gap that ranges from a distance dl to a distance d2, and pressing members 30, which are coupled to the upper member 20 and are disposed between the upper member 20 and the lower member 10.

The lower member 10 may be an elastic member that is already known, and the upper member 20 may be a cover member or a spoiler that is also already known. For convenience, the lower member 10 and the upper member 20 will hereinafter be referred to as the elastic member 10 and the cover member 20, respectively.

In a case in which the lower member 10 and the upper member 20 are referred to as the elastic member 10 and the cover member 20, respectively, the lower member 10 may be defined as being a member that is deformable, and the upper member 20 may be defined as being a member that is not deformable.

The wiper blade assembly 1 further includes a wiper arm coupling portion 40, which is coupled to the cover member 20.

The ends of the cover member 20 and the ends of the elastic member 10 may be coupled. For example, the ends of the cover member 20 and the ends of the elastic member 10 may be coupled either directly or indirectly through end caps that are already known.

FIGS. 1 and 2 illustrate that only the cover member 20 is coupled to the wiper arm coupling portion 40, but if necessary, the elastic member 10 may also be coupled to the wiper arm coupling portion 40.

The wiper arm coupling portion 40 is illustrated in FIGS. 1 and 2 as being disposed at a central part, in a longitudinal direction, of the wiper blade assembly 1, but may be disposed at an outer part of the wiper blade assembly 1. That is, the location of the wiper arm coupling portion 40 is not particularly limited.

The elastic member 10 may be in a state with no initial curvature.

The expression “the elastic member 10 being in the state with no initial curvature,” as used herein, may indicate that the elastic member 10 is yet to be subjected to a process of imparting an initial curvature.

More specifically, the expression “the elastic member 10 being in the state with no initial curvature,” as used herein, may mean that the elastic member 10 has an initial curvature of 0. However, since it is substantially difficult to fabricate an elastic member 10 with a curvature of 0, the expression “the elastic member 10 being in the state with no initial curvature,” as used herein, may preferably be interpreted as a state in which a process of imparting an initial curvature is yet to be performed on the elastic member 10.

Accordingly, since a process of imparting a curvature to an elastic member can be excluded from the fabrication of a flat-type wiper blade assembly, the manufacturing cost of a wiper blade assembly can be reduced.

A wiper arm (not illustrated) is connected to a driving shaft, which is connected to a vehicle-side wiper driving motor. It is obvious, to those skilled in the art, that the wiper blade assembly 1 can be driven by driving the wiper arm, which is coupled to the wiper arm coupling portion 40.

The wiper arm coupling portion 40 may include elements such as a connector and an adaptor, The structure of the wiper arm coupling portion 40 is already known to those skilled in the art, and thus, a detailed description thereof will be omitted.

The wiper blade assembly 1 according to the first exemplary embodiment will hereinafter be described in further detail.

As described above, the wiper blade assembly 1 includes the pressing members 30, which are coupled to the cover member 20 and are disposed between the cover member 20 and the elastic member 10.

FIG. 3 is a cross-sectional view illustrating the pressing members of the wiper blade assembly according to the first exemplary embodiment.

The pressing members 30 may be formed as curved leaf springs. The expression “the pressing members 30 being formed as curved leaf springs,” as used herein, may mean that the pressing members 30 are generally curved, but may preferably be interpreted that parts of the pressing members 30 that actually perform a “pressing” function are curved.

A plurality of pressing members 30 may be provided. For example, as illustrated in FIGS. 1 and 3, the pressing members 30 may include a first pressing member 30a, which is disposed adjacent to the wiper arm coupling portion 40, a second pressing member 30b, which is disposed to the end of the elastic member 10, and a third pressing member 30c, which is disposed between the first and second pressing members 30a and 30b.

FIGS. 1 and 2 illustrate that only one third pressing member 30c is provided between the first and second pressing members 30a and 30b, but alternatively, a plurality of third pressing members 30c may be provided between the first and second pressing members 30a and 30b.

Referring to FIG. 3, the first pressing member 30a includes a first coupling part 31a, which is coupled to a first part of the cover member 20, a first end 32a, which is disposed at a first-direction end of the first pressing member 30a with respect to the first coupling part 31a, and a second end 33a, which is disposed at a second-direction end of the first pressing member 30a with respect to the first coupling part 31a.

The first coupling part 31a may be coupled to the first part of the cover member 20 by coupling means that is already known. For example, the first coupling part 31a and the cover member 20 may be coupled using various methods such as screw coupling, riveting, bolt and nut fastening, and welding, but the present disclosure is not limited thereto. The description of how to couple the first coupling part 31a and the cover member 20 is directly applicable to the second and third pressing members 30b and 30c, which will be described later,

The first-direction end of the first pressing member 30a corresponds to the end of the first pressing member 30a dose to the elastic member 10, and the second-direction end of the first pressing member 30a corresponds to the end of the first pressing member 30a dose to the wiper arm coupling portion 40. The descriptions of the first- and second-direction ends of the first pressing member 30a are directly applicable to the second and third pressing members 30b and 30c, which will be described later,

The first pressing member 30a further includes a first connecting part 34a, which extends from the first coupling part 31a to the first end 32a of the first pressing member 30a, and a second connecting part 35a, which extends from the first coupling part 31a to the second end 33a of the first pressing member 30a.

A length La1 of the first connecting part 34a of the first pressing member 30a may be the same as, or different from, a length Lal of the second connecting part 35a of the first pressing member 30a.

In a case in which the lengths La1 and La2 differ from each other, the length of the part of the first pressing member 30a dose to the end of the elastic member 10, i.e., the length La2, may be greater than the length of the part of the first pressing member 30a dose to the wiper arm coupling portion 40, i.e., the length La1. The descriptions of the lengths La1 and La2 are directly applicable to the second and third pressing members 30b and 30c, which will be described later.

Referring further to FIG. 3, the second pressing member 30b includes a second coupling part 31b, which is coupled to a second part of the cover member 20, a first end 32b, which is disposed at a first-direction end of the second pressing member 30b with respect to the second coupling part 31b, and a second end 33b, which is disposed at a second-direction end of the second pressing member 30b with respect to the second coupling part 31b.

The second pressing member 30b further includes a first connecting part 34b, which extends from the second coupling part 31b to the first end 32b of the second pressing member 30b, and a second connecting part 35b, which extends from the second coupling part 31b to the second end 33b of the second pressing member 30b.

A length Lb1 of the first connecting part 34b of the second pressing member 30b may be the same as, or different from, alenath Lb2 of the second connecting part 35b of the second pressing member 30b.

Referring further to FIG, 3, the third pressing member 30c includes a third coupling part 31c, which is coupled to a third part of the cover member 20, a first end 32c, which is disposed at a first-direction end of the third pressing member 30c with respect to the third coupling part 31c, and a second end 33c, which is disposed at a second-direction end of the third pressing member 30c with respect to the third coupling part 31c.

The third pressing member 30c further includes a first connecting part 34c, which extends from the third coupling part 31c to the first end 32c of the third pressing member 30c, and a second connecting part 35c, which extends from the third coupling part 31c to the second end 33c of the third pressing member 30c.

A length Lc1 of the first connecting part 34c of the third pressing member 30c may be the same as, or different from, a length Lc2 of the third connecting part 35c of the third pressing member 30c.

In short, each of the pressing members 30 includes a coupling part, which is coupled to a predetermined part of the cover member 20, and first and second ends, which are disposed at first- and second-direction ends, respectively, of a corresponding pressing member 30 with respect to the coupling part, and further includes a first connecting part, which extends from the coupling part to the first end, and a second connecting part, which extends from the coupling part to the second end.

As described above, the pressing members 30 may include the first pressing member 30a, which is disposed adjacent to the wiper arm coupling portion 40, and the second pressing member 30b, which is disposed adjacent to the end of the elastic member 10.

As described above, the first pressing member 30a may include the first connecting part 34a, which extends from the first coupling part 31a to the first end 32a of the first pressing member 30a, and the second connecting part 35a, which extends from the first coupling part 31a to the second end 33a of the first pressing member 30a, and the second pressing member 30b may include the connecting part 34b, which extends from the second coupling part 31b to the first end 32b of the second pressing member 30b, and the second connecting part 35b, which extends from the second coupling part 31b to the second end 33b of the second pressing member 30b.

The length La2 of the second connecting part 35a of the first pressing member 30a may preferably be greater than the length Lb2 of the second connecting part 35b of the second pressing member 30b.

Also, a height hb from the second end 33b to the second coupling part 31b of the second pressing member 30b may be greater than a height ha from the second end 33a to the first coupling part 31a of the first pressing member 30a.

An operating state of the wiper blade assembly 1 will hereinafter be described with reference to FIGS, 1 and 2.

As illustrated in FIG, 1, in the wiper blade assembly 1, the lower member 10 (i.e., the elastic member 10), which supports the adhering member, and the upper member 20 (i.e., the cover member 20) are spaced apart from each other by a predetermined gap that ranges from the distance dl to the distance d2, and the pressing members 30 are disposed in the predetermined gap and are coupled to the cover member 20.

The elastic member 10 and the cover member 20 may be coupled to the wiper arm coupling portion 40.

Referring to FIG. 1, reference character W represents a wind shield glass surface, and the wind shield glass surface W has a predetermined curvature.

As described above, the elastic member 10 may be in the state with no initial curvature. That is, as illustrated in FIG. 1, the elastic member 10 may have an initial curvature of 0.

However, since it is substantially difficult to fabricate an elastic member 10 with a curvature of 0, the expression “the elastic member 10 being in the state with no initial curvature,” as used herein, may preferably be interpreted as a state in which a process of imparting an initial curvature is yet to be performed on the elastic member 10.

As illustrated in FIG. 2, in response to the wiper arm being driven to press the wiper arm coupling portion 40 with a force A, the force A is transmitted to the cover member 20.

The force A transmitted to the cover member 20 presses the coupling parts of the pressing members 30, which are coupled to the cover member 20, with forces B₁, B₂, and B₃, and the forces B₁, B₂, and B₃ are transmitted to the first ends and/or the second ends of the pressing members 30.

The forces B₁, B₂, and B₃ transmitted to the first ends and/or the second ends of the pressing members 30 press the elastic member 10 with forces C₁, C₂, and C₃, and as a result, the elastic member 10 is deformed.

That is, the predetermined gap between the elastic member 10 and the cover member 20, ranging from the distance d1 to the distance d2, may be transformed into a gap ranging from a distance d1′ to a distance d2′, and the elastic member 10 is deformed accordingly.

Due to the deformation of the elastic member 10, the adhering member supported by the elastic member 10 may be able to effectively wipe any foreign materials off of a wind shield of a vehicle.

As described above, the length La1 of the second connecting part 35a of the first pressing member 30a may preferably be greater than the length Lb2 of the second connecting part 35b of the second pressing member 30b, or the height hb from the second end 33b to the second coupling part 31b of the second pressing member 30b may be greater than the height ha from the second end 33a to the first coupling part 31a of the first pressing member 30a.

That is, the length of the second connecting parts of the pressing members 30 may become greater closer to the end of the elastic member 10.

Accordingly, a pressing member 30 dose to the end of the elastic member 10 may be able to apply a stronger pressing force than a pressing member 30 distant from the end of the elastic member 10.

For example, as illustrated in FIG. 2, the force A transmitted to the cover member 20 may press the coupling parts of the pressing member 30, which are coupled to the cover member 20, with the forces B₁, B₂, and B₃, and the force applied to the coupling parts of the pressing member 30 may become weaker further away from the wiper arm coupling portion 40.

Therefore, in order to compensate for the pressing force applied to the coupling parts of pressing members 30 that are relatively distant from the wiper arm coupling portion 40, the length of the second connecting part of a pressing member 30 dose to the end of the elastic member 10 may preferably be set to be greater than the length of the second connecting parts of the other pressing members 30.

Similarly, in order to compensate for the pressing force applied to the coupling parts of pressing members 30 that are relatively distant from the wiper arm coupling portion 40, the second end-to-coupling part height of a pressing member 30 dose to the end of the elastic member 30 may preferably be set to be greater than the second end-to-coupling part height of the other pressing members 30.

Referring to FIG. 2, the first pressing member 30a presses the elastic member 10 at both the first and second ends 32a and 33a, whereas the second or third pressing member 30b or 30c presses the elastic member 10 only at the second end 33b or 33c. Alternatively, by appropriately adjusting the length of the connecting parts of the pressing members 30, the first through third pressing members 30a through 30c may all be configured to be able to press the elastic member 10 at both the first and second ends thereof or only at the second end thereof.

As described above, an elastic member for a typical flat blade assembly may be formed to have an initial curvature and flexibility, and may thus be deformable due to its flexibility.

Accordingly, since the adhesion properties of the typical flat-type wiper blade assembly with respect to a wind shield of a vehicle are determined by the initial curvature of the elastic member, the elastic member may not be able to be properly deformed for various wind shield surfaces with various curvatures.

On the other hand, in the wiper blade assembly 1, which is a flat-type wiper blade assembly, the pressing members 30, which have a relatively simple structure, are disposed between the cover member 20 and the elastic member 10, and the elastic member 10 may be pressed, through the pressing members 30, by the pressing force applied by the wiper arm.

Due to the deformation of the elastic member 10 by the pressing members 30, the adhering member supported by the elastic member 10 may be able to effectively wipe any foreign materials off of a wind shield of a vehicle.

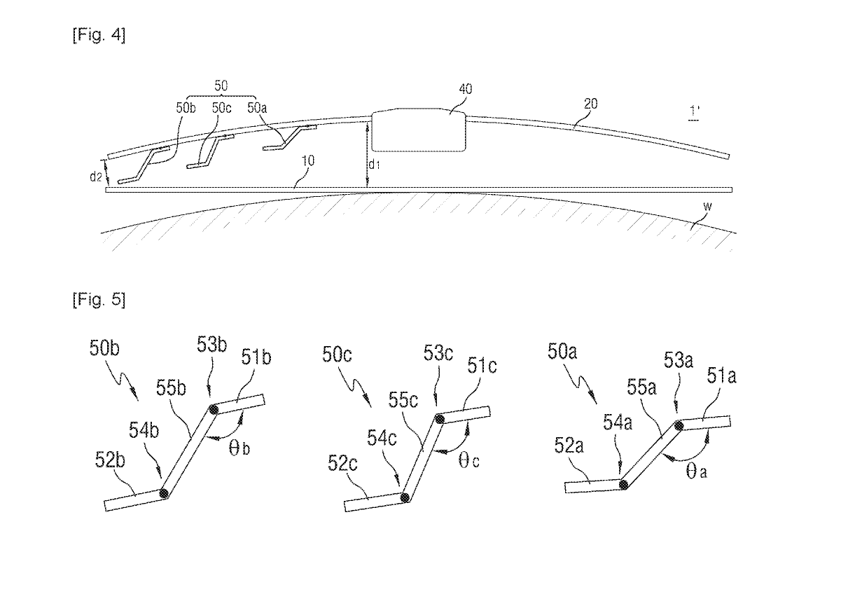

FIG. 4 is a schematic view illustrating a wiper blade assembly according to a second exemplary embodiment of the present disclosure, and FIG. 5 is a cross-sectional view illustrating pressing members of the wiper blade assembly according to the second exemplary embodiment.

A wiper blade assembly 1′ according to the second exemplary embodiment is almost the same as the wiper blade assembly 1 according to the first exemplary embodiment.

More specifically, the wiper blade assembly 1′ is the same as the wiper blade assembly 1 except for the shape of pressing members 50.

Referring to FIGS. 4 and 5, the pressing members 50 may be formed as straight leaf springs. The expression “the pressing members 50 being formed as straight leaf springs,” as used herein, may mean the pressing members 50 are generally straight, but may preferably be interpreted that parts of the pressing members 50 that actually perform a “pressing” function are straight.

The pressing members 30 of the wiper blade assembly 1 of FIG. 3 may also be configured to be straight, rather than curved.

That is, the pressing members 30 are defined as being curved leaf springs because the first and second connecting parts of each of the pressing members 30 that actually perform a “pressing” function are curved.

Alternatively, the first and second connecting parts of each of the pressing members 30 may be configured to be straight, rather than curved, in which case, the pressing members 30, like the pressing members 50, may be defined as being straight leaf springs.

The pressing members 50 of the wiper blade assembly 1′ will hereinafter be described with reference to FIGS. 4 and 5.

A plurality of pressing members 50 may be provided. For example, as illustrated in FIGS. 4 and 5. the pressing members 50 may include a first pressing member 50a, which is disposed adjacent to a wiper arm coupling portion 40, a second pressing member 50b, which is disposed adjacent to the end of an elastic member 10, and a third pressing member 50c, which is disposed between the first and second pressing members 50a and 50b.

FIGS. 4 and 5 illustrate that only one third pressing member 50c is provided between the first and second pressing members 50a and 50b, but alternatively, a plurality of third pressing members 50c may be provided between the first and second pressing members 50a and 50b.

Referring to FIG. 5, the first pressing member 50a includes a first coupling part 51a, which is coupled to a first part of a cover member 20, a first connecting part 55a, which is disposed in series with the first coupling part 51a and is bent from the first coupling part 51a at a first bent part 53a, and a first sliding part 52a, which is disposed in series with the first connecting part 55a and is bent from the first connecting part 55a at a second bent part 54a.

For example, the first coupling part 51a and the cover member 20 may be coupled using various methods such as screw coupling, riveting, bolt and nut fastening, and welding, but the present disclosure is not limited thereto. The description of how to couple the first coupling part 51a and the cover member 20 is directly applicable to the second and third pressing members 50b and 50c, which will be described later.

As described above, the pressing members 50 may be formed as straight leaf springs,

That is, as illustrated in FIGS. 4 and 5, since the first coupling part 55a that actually performs a “pressing” function is straight, the pressing member 50a may be defined as being a straight leaf spring.

Alternatively, the first connecting part 55a may be curved, in which case, the pressing member 50a, like its counterpart according to the first exemplary embodiment, may be defined as being a curved leaf spring. The description of the first pressing member 50a is directly applicable to the second and third pressing members 50b and 50c, which will be described later.

The first sliding part 52a is slidably movable from a predetermined surface that it is placed in contact with.

The first connecting part 55a may be bent from the first coupling part 51a by a first angle θₐ.

The first angle θₐ may be calculated as the angle between the first coupling part 51a and the first connecting part 55a, but may also be calculated as the angle between the first connecting part 55a and the first part of the cover member 20 to which the first coupling part 51a is coupled. The description of the first angle θₐ is directly applicable to the second and third pressing members 50b and 50c, which will be described later.

Referring further to FIG. 5, the second pressing member 50b includes a second coupling part 51b, which is coupled to a second part of the cover member 20, a second connecting part 55b, which is disposed in series with the second coupling part 51b and is bent from the second coupling part 51b at a first bent part 53b, and a second sliding part 52b, which is disposed in series with the second connecting part 55b and is bent from the second connecting part 55b at a second bent part 54b.

The second connecting part 55b may be bent from the second coupling part 51b by a second angle θ_{b}.

The third pressing member 50c includes a third coupling part 51c, which is coupled to a third part of the cover member 20, a third connecting part 55c, which is disposed in series with the third coupling part 51c and is bent from the third coupling part 51c at a first bent part 53c, and a third sliding part 52c, which is disposed in series with the third connecting part 55c and is bent from the third connecting part 55c at a second bent part 54c.

The third connecting part 55c may be bent from the third coupling part 51c by a third angle θ_{c}.

The second angle θ_{b} may preferably be smaller than the first angle θₐ. For this end, the length of the second connecting part 55b may preferably be greater than the length of the first connecting part 55a, as illustrated in FIG. 5.

That is, the angle that the coupling part (or a part of the cover member 20 to which the corresponding coupling part is coupled) and the connecting part of a pressing member 50 close to the end of an elastic member 10 form with each other may preferably be smaller than the angle that the coupling part (or a part of the cover member 20 to which the corresponding coupling part is coupled) and the connecting part of a pressing member 50 distant from the end of the elastic member 10 form with each other.

In this regard, the pressing members 50 have the same operating principle as the pressing members 30 according to the first exemplary embodiment.

That is, the angle that the coupling part (or a part of the cover member 20 to which the corresponding coupling part is coupled) and the connecting part of each of the pressing members 50 form with each other becomes smaller closer to the end of the elastic member 10.

Accordingly, a pressing member 50 close to the end of the elastic member 10 may be able to apply a stronger pressing force than a pressing member 50 distant from the end of the elastic member 10.

Therefore, in order to compensate for the pressing force applied to the coupling parts of pressing members 50 that are relatively distant from the wiper arm coupling portion 40, the angle that the coupling part (or a part of the cover member 20 to which the corresponding coupling part is coupled) and the connecting part of a pressing member 50 dose to the end of the elastic member 10 form with each other may preferably be set to be smaller than the angle that the coupling part (or a part of the cover member 20 to which the corresponding coupling part is coupled) and the connecting part of a pressing member 50 less close to the end of the elastic member 10 form with each other.

The operating state of the wiper blade assembly 1′ according to the second exemplary embodiment is almost the same as the operating state of the wiper blade assembly 1 according to the first exemplary embodiment.

More specifically, in response to a wiper arm being driven to press the wiper arm coupling portion 40 with a force A, the force A is transmitted to the cover member 20.

The force A transmitted to the cover member 20 presses the coupling parts of the pressing members 50, which are coupled to the cover member 20, with predetermined forces, and the predetermined forces are transmitted to the connecting parts of the pressing members 50.

The forces transmitted to the connecting parts of the pressing members 50 are transmitted to the sliding parts of the pressing members 50, and the sliding parts of the pressing members 50 press the surface that they are placed in contact with, and as a result, the elastic member 10 is deformed.

The sliding parts of the pressing members 50 may press the elastic member 10, while moving along the surface that they are placed in contact with. As a result, the elastic member 10 may be deformed.

Due to the deformation of the elastic member 10, the adhering member supported by the elastic member 10 may be able to effectively wipe any foreign materials off of a wind shield of a vehicle.

An application example of a wiper blade assembly according to an exemplary embodiment of the present disclosure will hereinafter be described.

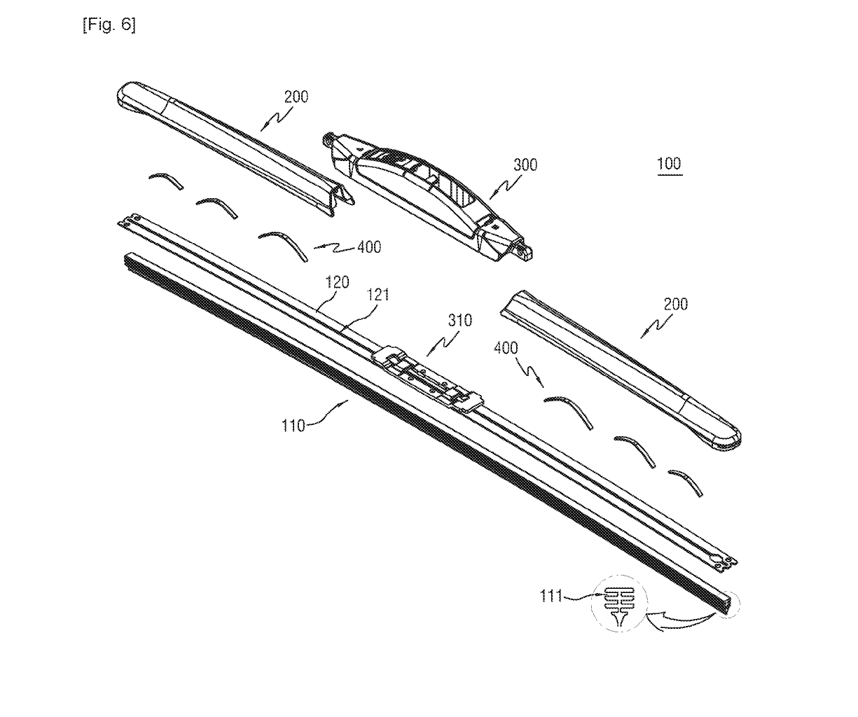

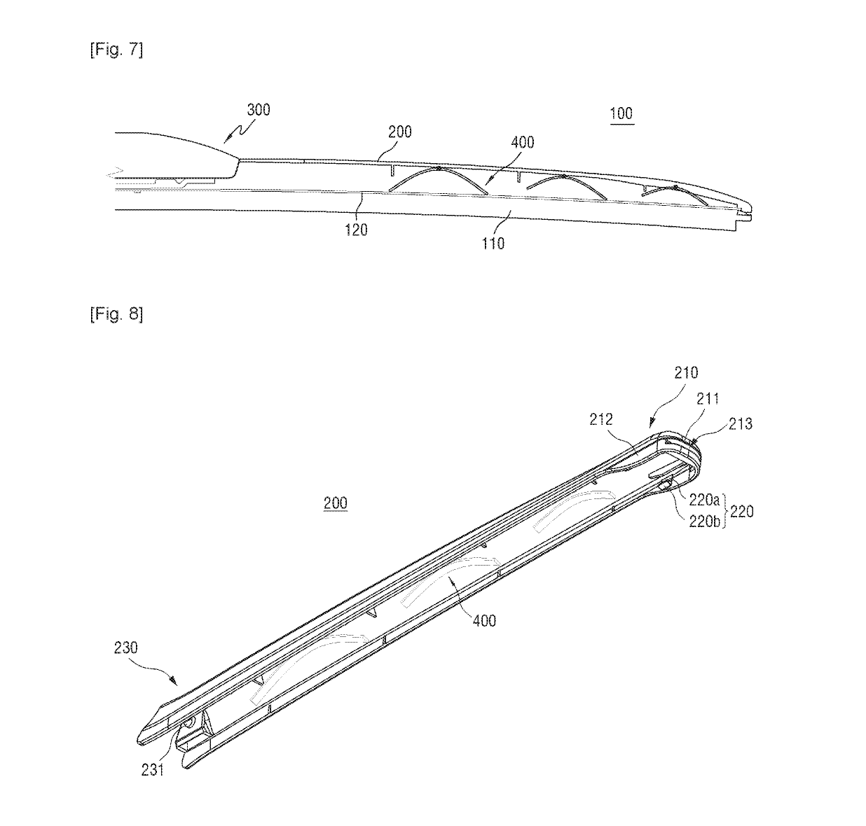

FIG. 6 is an exploded perspective view illustrating an application example of a wiper blade assembly according to an exemplary embodiment of the present disclosure, and FIG. 7 is a cross-sectional view illustrating the wiper blade assembly of FIG. 6.

FIGS. 6 and 7 illustrate an exemplary wiper blade assembly including the pressing members according to the first exemplary embodiment. However, it is obvious that the pressing members according to the second exemplary embodiment are also applicable to the exemplary wiper blade assembly of FIGS. 6 and 7.

The pressing members according to the first exemplary embodiment have already been described above, and thus, a detailed description thereof will be omitted.

Referring to FIGS. 6 and 7, a wiper blade assembly 100 includes an adhering member 110, which is formed of a rubber material and is placed in contact with a windshield of a vehicle, a lower member 120, which supports the adhering member 110, an upper member 200, which is spaced apart from the lower member 120 by a predetermined gap, and pressing members 400, which are coupled to the upper member 200 and are disposed between the upper member 200 and the lower member 120.

The lower member 120 may be an elastic member that is already known, and the upper member may be a cover member or a spoiler that is also already known. For convenience, the lower member 120 and the upper member 200 will hereinafter be referred to as the elastic member 120 and the cover member 200, respectively.

The wiper blade assembly 100 further includes a wiper arm coupling portion 300, which is coupled to the elastic member 120 and the cover member 200.

The elastic member 120 may be coupled to the wiper arm coupling portion 300 by coupling a clamp 310, which is coupled to the elastic member 120, to the wiper arm coupling portion 300.

The cover member 200 may be hinge-coupled to the wiper arm coupling portion 300. For more information on this type of coupling between the cover member 200 and the wiper arm coupling portion 300 see Korean Patent Application No. 10-2012-0033293.

The elastic member 120 includes a slit 121, which is formed along a longitudinal direction of the elastic member 120, and the adhering member 110 may include slit grooves 111. In response to and the slit 121 of the elastic member 120 and the slit grooves 111 of the adhering member 110 being coupled, the elastic member 120 may be able to support the adhering member 110.

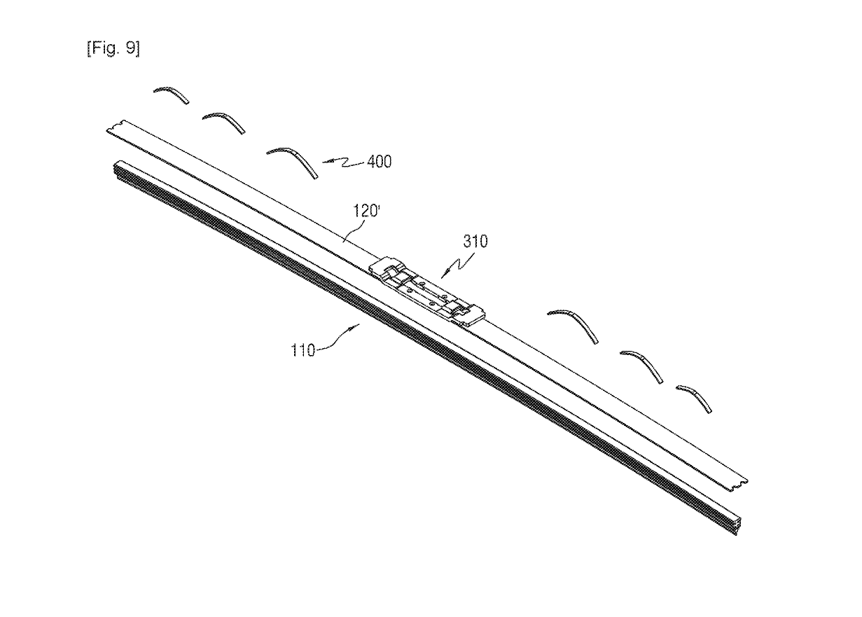

FIG. 9 is a schematic perspective view illustrating a modified example of an elastic member according to an exemplary embodiment of the present disclosure.

Referring to FIG. 9, an elastic member 120′, unlike the elastic member 120 of FIG. 6, may not include any slit grooves.

In this case, an adhering member 110 may be adhered onto the bottom of the elastic member 120′ by adhering means that is already known, and as a result, the elastic member 120′ may be able to support the adhering member 110.

The differences between the elastic member 120 of FIG. 6 and the elastic member 120′ of FIG. 9 are as follows.

The elastic member 120 is coupled to the adhering member 110 such that the adhering member 110 is disposed at the top of the elastic member 120. On the other hand, the adhering member 110 is adhered onto the bottom of the elastic member 120′ and is thus not disposed at the top of the elastic member 120′.

As described above, in response to the pressing members 400 pressing the elastic member 120 or 120′, the elastic member 120 or 120′ is deformed due to its elasticity. In the exemplary embodiment of FIG. 6, the pressing members 400 press the elastic member 120 indirectly by pressing the adhering member 110. On the other hand, in the exemplary embodiment of FIG. 9, the pressing members 400 directly press the elastic member 120.

An exemplary cover member for the wiper blade assembly of FIGS. 6 and 7 will hereinafter be described with reference to FIG. 8. However, the present disclosure is not limited to the exemplary cover member of FIG. 8.

FIG. 8 is a perspective view illustrating an exemplary cover member for the wiper blade assembly of FIGS. 6 and 7.

Referring to FIG. 8, the pressing members 400 may be coupled to a cover member 200 by using various methods such as screw coupling, riveting, bolt and nut fastening, and welding.

The cover member 200 may be formed to extend in the longitudinal direction of the elastic member 120 to cover one end (for example, a right end) of the elastic member 120.

A part of the cover member 200 that covers the end of the elastic member 120 may be defined as a first end portion 210.

That is, the cover member 200 may include the first end portion 210, which covers the end of the elastic member 120, and may be formed to extend along the longitudinal direction of the elastic member 120.

The first end portion 210 of the cover member 200 includes a front part 211 and side parts 212, which are disposed on both sides of the front part 211, and the front part 211 includes an entrance 213, which allows the elastic member 120 to enter or exit the cover member 200.

More specifically, the wiper blade assembly 100 includes the adhering member 110, which wipes any foreign materials off of a wind shield of a vehicle, the elastic member 120, which supports the adhering member 110, and the cover member 200, which covers the end of the elastic member 120. When the wiper blade assembly 100 is not in operation the elastic member 120, which supports the adhering member 110, is bent with a predetermined curvature. When the wiper blade assembly 100 is in operation, the elastic member 120 is deformed according to the shape of the wind shield, and as a result, the curvature of the elastic member 120 changes.

Since during the operation of the wiper blade assembly 100, the elastic member 120 is deformed according to the shape of the wind shield and the curvature of the elastic member 120 changes accordingly, the entrance 213 may become movable along the longitudinal direction of the elastic member 120.

In general, when the wiper blade assembly 100 is not in operation, the elastic member 120 is bent with the predetermined curvature, and when the wiper blade assembly 100 is in operation, the elastic member 120 may be straightened due to the adhesion between the adhering member and the wind shield, in which case, the straightening of the elastic member 120 may be interfered with by the presence of the cover member 200, which covers the end of the elastic member 120.

However, since the entrance 213 is provided at the front of the cover member 200 and the end of the elastic member 120 is movable along the longitudinal direction of the elastic member 120 through the entrance 213, the adhering member 110 and the wind shield may be able to be firmly adhered to each other.

Referring further to FIG. 8, a supporting portion 220, which supports the elastic member 120, is provided on the inside of the cover member 200. The supporting portion 220 includes a vertical support 220a, which supports a side of the elastic member 120 and prevents the elastic member 120 from deviating laterally from the cover member 200, and a horizontal support 220b, which supports the bottom of the elastic member 120 and prevents the elastic member 120 from deviating downwardly from the cover member 200.

That is, since the supporting portion 220, which is substantially “└” or “┘” shaped, is provided on the inside of the cover member 200, the cover member 200 may support the side and the bottom of the elastic member 120 and may prevent the elastic member 120 from deviating laterally and downwardly therefrom.

More specifically, the supporting portion 220 includes the vertical support 220a, which is substantially “|”-shaped, and is thus able to prevent the elastic member 120 from deviating laterally from the cover member 200. The supporting portion 220 further includes the horizontal support 220b, which is substantially “—”-shaped, and is thus able to prevent the elastic member 120 from deviating downwardly from the cover member 200,

When the bottom surface of the elastic member 120 is placed in contact with the top surface of the horizontal support 220b, the horizontal support 220b prevents the elastic member 120 from deviating downwardly from the cover member 200.

The supporting portion 220 not only prevents the elastic member 120 from deviating laterally or downwardly from the cover member 200, but also serves as a guide for the movement of the elastic member 120 along the longitudinal direction of the elastic member 120.

That is, during the operation of the wiper blade assembly 100, the end of the elastic member 120 is movable in the longitudinal direction of the elastic member 120 through the entrance 213. More specifically, the elastic member 120 may be movable along the longitudinal direction of the elastic member 120 through the entrance 213, while being supported and guided by the vertical support 220a and the horizontal support 220b.

In the first exemplary embodiment described above with reference to FIG. 1, the elastic member 10 and the cover member 20 may both be coupled to the wiper arm coupling portion 40, but the present disclosure is not limited thereto. That is, alternatively, only the cover member 20 may be coupled to the wiper arm coupling portion 40, and the elastic member 10 may be coupled to the cover member 20.

More specifically, as described above with reference to FIG. 8, the cover member 200 includes the supporting portion 220, which is provided on the inside of the cover member 200 and is substantially “└” or “┘”-shaped. Thus, the cover member 200 may support the side and the bottom of the elastic member 120 and may prevent the elastic member 120 from deviating laterally or downwardly therefrom.

In this case, the elastic member 120 may not be coupled to a wiper arm coupling portion 300. Instead, the elastic member 120 may be coupled to the cover member 200 by being supported by the supporting portion 220 of the cover member 200,

The cover member 200 may further include a second end portion 230, which is disposed on the opposite side of the first end portion 210 that covers the end of the elastic member 120, and a coupling protrusion 231, which is disposed in a predetermined area on the inside of the second end portion 230.

That is, as described above, the cover member 200 may be hinge-coupled to the wiper arm coupling portion 300 by coupling the coupling protrusion 231 of the cover member 200 and a coupling protrusion (not illustrated) located in a predetermined area on the wiper arm coupling portion 300.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wiper blade assembly, comprising:
an adhering member;
a lower member supporting the adhering member;
an upper member spaced apart from the lower member by a predetermined gap; and
pressing members coupled to the upper member and disposed between the upper member and the lower member.

2. The wiper blade assembly of claim 1, wherein
the lower member is an elastic member, and
the upper member is a cover member.

3. The wiper blade assembly of claim 1, wherein the pressing members are formed as curved leaf springs or straight leaf springs.

4. The wiper blade assembly of claim 2, further comprising:
a wiper arm coupling portion coupled to the elastic member and the cover member, or coupled to the cover member.

5. The wiper blade assembly of claim 4, wherein the pressing members include a first pressing member, which is disposed adjacent to the wiper arm coupling portion, and a second pressing member, which is disposed adjacent to an end of the elastic member.

6. The wiper blade assembly of claim 5, wherein
the first pressing member includes a first coupling part, which is coupled to a first part of the cover member, a first end, which is disposed at a first-direction end of the first pressing member with respect to the first coupling part, a second end, which is disposed at a second-direction end of the first pressing member with respect to the first coupling part, a first connecting part, which extends from the first coupling part to the first end of the first pressing member, and a second connecting part, which extends from the first coupling part to the second end of the first pressing member, and
the second pressing member includes a second coupling part, which is coupled to a second part of the cover member, a first end, which is disposed at a first-direction end of the second pressing member with respect to the second coupling part, a second end, which is disposed at a second-direction end of the second pressing member with respect to the second coupling part, a first connecting part, which extends from the second coupling part to the first end of the second pressing member_{;} and a second connecting part_{;} which extends from the second coupling part to the second end of the second pressing member.

7. The wiper blade assembly of claim 6, wherein a length of the second connecting part of the first pressing member is greater than a length of the second connecting part of the second pressing member.

8. The wiper blade assembly of claim 5, wherein
the first pressing member includes a first coupling part, which is coupled to a first part of a cover member, a first connecting part, which is disposed in series with the first coupling part and is bent from the first coupling part at a first bent part of the first pressing member, and a first sliding part, which is disposed in series with the first connecting part and is bent from the first connecting part at a second bent part of the first pressing member, and
the second pressing member includes a second coupling part, which is coupled to a second part of the cover member, a second connecting part, which is disposed in series with the second coupling part and is bent from the second coupling part at a first bent part of the second pressing member, and a second sliding part, which is disposed in series with the second connecting part and is bent from the second connecting part at a second bent part of the second pressing member.

9. The wiper blade assembly of claim 8, wherein
the first connecting part is bent from the first coupling part by a first angle,
the second connecting part is bent from the second coupling part by a second angle, and
the second angle is smaller than the first angle.
